(19) United States
(12) Patent Application Publication
(10) Pub. No.: US 2018/0085948 A1
(43) Pub. Date: Mar. 29, 2018

(54) ELECTRICALLY-DRIVEN RAZOR

(71) Applicant: Braun GmbH, Kronberg (DE)

(72) Inventors: Joachim Krauss, Seeheim-Jugenheim (DE); Detlef Gleich, Friedrichsdorf (DE); Wolfgang Stegmann, Frankfurt am Main (DE)

(21) Appl. No.: 15/717,046

(22) Filed: Sep. 27, 2017

(30) Foreign Application Priority Data
Sep. 28, 2016 (EP) 16191113.6
Sep. 25, 2017 (EP) 17192948.2

(51) Int. Cl. B26B 19/28; B26B 19/38

(52) U.S. Cl. CPC B26B 19/28; B26B 19/3853

(57) ABSTRACT

An electrically-driven razor includes a handle and a slim, lightweight head. The handle includes a housing, a motor, a transmission, at least one driven shaft, and a coupling. The motor is contained substantially within the housing. The head includes a skin-engaging portion. The coupling links the head to the housing. The at least one driven shaft extends into the head. The transmission is constructed to translate rotary motion of the motor to reciprocating motion of the at least one driven shaft. The head is pivotable in at least two dimensions, relative to the housing.

### FIELD OF THE INVENTION

The present disclosure generally relates to an electrically-driven razor/shaver with lightweight head for providing an improved ergonomic experience as well as improved efficacy.

### BACKGROUND OF THE INVENTION

Hair removal devices of the type named above are known in the prior art. There are a large number of different hair removal devices that are designed according to different principles of operation. For example, such devices can incorporate rotary systems with several circular rotating blades. Other devices can incorporate linear foil-type systems with linearly oscillating cutting units arranged side by side in a shaver head.

Known dry shavers (e.g., electrically-driven razors) typically include a multi-functional head having several cutting units for long hair and/or short hair cutting. For example, the head may include a cartridge foil-type cutting units and/or center-trimmers. The cartridge is typically assembled with a chassis or lower frame, which may allow for a flexible connection, enabling micro-movement of cutting parts relative to the head. The assembly may typically include, among other parts, bearings, an oscillating bridge, and a swivel groove, all of which require installation space in the head. Some known shavers may include a motor, or at least a portion thereof, within the head, and in many cases, the frame-like assembly is covered by a hood. With the inclusion of all or some of such parts, the resulting head is typically bulky and heavy relative to the handle or body.

Dry shavers can be known to include a shaving head that is moveable relative to the handle or body in order to properly adapt to the skin contour (i.e., macro-movement). For example, it is known for a shaver head to be pivotable about an axis corresponding to the linear movement of the hair cutting units (i.e., a swivel axis). It is also known for a shaver to allow head movement along an axis that is perpendicular to the above-described swivel axis (i.e., a tilt axis). To facilitate such movement, known dry shavers may include an oscillating bridge to facilitate transfer of eccentric rotary motor drive movement into linear movement and to couple the motor drive to the head, independently from movement of the shaver head relative to the handle or body.

What is desired is an electrically-driven razor that requires fewer parts than the above-described, known razors/shavers and allows for a lightweight head, which may exhibit low inertia. What is also desired is an electrically-driven razor that can translate rotary motion of the motor to linear, reciprocating motion in the head, even without the additional parts, such as, for example, an oscillating bridge. What is further required is an electrically-driven razor having a narrow head-handle coupling and a head that may swivel and tilt relative to a handle.

### SUMMARY OF THE INVENTION

In accordance with one embodiment, an electrically-driven razor includes a handle and a head. The handle includes a housing, a motor, a transmission, at least one driven shaft, and a coupling. The motor is contained substantially within the housing. The head includes a skin-engaging portion. The coupling links the head to the housing. The at least one driven shaft extends into the head. The transmission is constructed to translate rotary motion of the motor to reciprocating motion of the at least one driven shaft. The head is pivotable in at least two dimensions, relative to the housing. A ratio of a weight of the head to a weight of the handle is less than about 0.21. By arranging the transmission (32) for translating rotary motion of the motor (30) to reciprocating motion of the at least one driven shaft (46, 48) in the handle an oscillation bridge element and coupling to that are no longer needed within the head. Thus more weight is provided within the handle and less in the head as provided in the prior art allowing the handle to easily stabilize he head. The head is kept lightweight and easy to follow a skin contour and a low force is needed to act on the head for changing the angular position relative to the handle. Moreover the complete head design is optimized with respect to a low number of parts for achieving a low head weight.

In accordance with another embodiment, an electrically-driven razor includes a handle and a head. The handle includes a housing, a motor, a transmission, at least one driven shaft, and a coupling. The motor is contained substantially within the housing. The head includes a skin-engaging portion. The coupling links the head to the housing. The at least one driven shaft extends into the head. The transmission is constructed to translate rotary motion of the motor to reciprocating motion of the at least one driven shaft. The head is pivotable in at least two dimensions, relative to the housing. A ratio of a minimum coupling diameter D2 to a maximum handle diameter D6 is about 0.50 or less. This is achieved by arranging the transmission (32) for translating rotary motion of the motor (30) to reciprocating motion of the at least one driven shaft (46, 48) in the handle which expands the diameter of the handle and minimizes the diameter of the connecting portion between handle and head. Thus only a central drive shaft is provided for connecting the head with the handle and as far as a shaver head is provided which is moveable relative to the handle a tilt mechanism is provided such that a tailored contour around the neck is achieved with a low minimum coupling diameter D2.

### BRIEF DESCRIPTION OF THE DRAWINGS

FIG. 1 depicts a front view of an electrically-driven razor, according to one embodiment;

FIG. 2 depicts an isometric view of a top portion of the electrically-driven razor of FIG. 1;

FIG. 3 depicts the electrically-driven razor of FIG. 1, with a cross-sectional view of the head, a dotted outline of a housing of the handle, and a portion of the head removed to more effectively allow for such views;

FIG. 4 depicts a schematic view of a first support member and a four-link mechanism of the electrically-driven razor of FIG. 1, with a different portion of the head removed to more effectively allow for such view.

### DETAILED DESCRIPTION OF THE INVENTION

The following text sets forth a broad description of numerous different embodiments. The description is to be construed as exemplary only and does not describe every possible embodiment since describing every possible embodiment would be impractical, if not impossible, and it will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

It should also be understood that, unless a term is expressly defined in this specification using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). No term is intended to be essential unless so stated. To the extent that any term recited in the claims at the end of this patent is referred to in this patent in a manner consistent with a single meaning, that is done for sake of clarity only so as to not confuse the reader, and it is not intended that such a claim term be limited, by implication or otherwise, to that single meaning.

In order to improve comfort and operability for a user, an electrically-driven razor can include a handle, the handle including a housing; a motor, the motor being contained substantially within the housing; a transmission; at least one driven shaft; and a coupling; and a head, the head including a skin-engaging portion; where the coupling links the head to the housing, the at least one driven shaft extends into the head, and the transmission is constructed to translate rotary motion of the motor to reciprocating motion of the at least one driven shaft; where the head is pivotable in at least two dimensions, relative to the housing; and characterized in that a ratio of a weight of the head to a weight of the handle is less than about 0.21. Such a ratio can incorporate a previously-unknown low weight for a shaver head.

In order to provide improved adaptability of the head to skin contour and to reduce a user's burden of adapting to skin contour through the handle, the head can include, in certain embodiments, a contour-following element, where the contour-following element can include the skin-engaging portion and can be pivotable in three dimensions, relative to the housing. In view of the low ratio of the weight of the head to the weight of the handle, the head poses a very low mass of inertia for movement of the head relative to the housing (i.e., macro-movement). This allows for smooth adaptability of the head to skin contour, while minimizing or elimination deflection in the handle. As such, providing the low ratio of the weight of the head to the weight of the handle allows for sufficient separation of forces acting on the head from those forces acting on the handle as the user moves the razor over skin contour.

In order to further improve adaptability and to provide a lightweight swivel mechanism and good flexing at various neck and facial positions, the handle can include a first support member having a first tab and second tab, where the first support member can extend along substantially a length of the head, where the first tab can be rotatably coupled to a first end of the contour-following element and the second tab can be rotatably coupled to a second end of the contour-following element. In certain embodiments, respective connection points between the first tab and the first end of the contour-following element and the second tab and the second end of the contour-following element can define a swivel axis about which the contour-following element is capable of swiveling.

In order to further improve adaptability and good flexing at various neck and facial positions, and to provide a lightweight tilt mechanism, the coupling can include a four-link support mechanism having a first arm and a second arm, each of the first arm and the second arm having a lower portion and an upper portion, where the lower portion of each of the first arm and the second arm can be rotatably coupled to the housing, and where the upper portion of each of the first arm and the second arm can be rotatably coupled to the first support member. In certain embodiments, the four-link support mechanism can allow for tilting movement of the contour-following element, relative to the housing.

In order to more effectively capture and cut hairs, the skin-engaging portion can include one or more hair cutting units, and in certain embodiments, the at least one driven shaft can include a first driven shaft and a second driven shaft, where each of the first driven shaft and the second driven shaft can be coupled to one of the one or more hair cutting units.

In order to improve operability of the electrically-driven razor the first driven shaft and the second driven shaft can be coupled by a bridge, and the bridge can be coupled to an intermediate shaft, such that the bridge can be rotationally constrained relative to the intermediate shaft. In certain embodiments, the one or more hair cutting units can include a first foil-type cutting unit and a second foil-type cutting unit, where the first driven shaft can be coupled to the first foil-type cutting unit with a first bearing sleeve, where the second driven shaft can be coupled to the second foil-type cutting unit with a second bearing sleeve, and where the first bearing sleeve and the second bearing sleeve can be rotatable and axially displaceable with respect to the first driven shaft and the second driven shaft, respectively.

In order to provide a more improved ergonomic handle-holding experience, the handle can include a finger rest. In certain embodiments, the finger rest can be a projection from a top, rear portion of the handle, such that the finger rest can be configured to engage, for example, a user's index finger.

In order to improve comfort and operability for a user, the ratio of the weight of the head to the weight of the handle can be from about 1:5 to about 1:8; or more preferably, from about 1:5 to about 1:7. In certain embodiments, the ratio of the weight of the head to the weight of the handle can be less than about 0.20; less than about 0.19; or less than about 0.18.

In order to further improve adaptability of the head to skin contour and good flexing at various neck and facial positions, an electrically-driven razor can include a handle, the handle including a housing; a motor, the motor being contained substantially within the housing; a transmission; at least one driven shaft; and a coupling; and a head, the head including a skin-engaging portion; where the coupling links the head to the housing, the at least one driven shaft extends into the head, and the transmission is constructed to translate rotary motion of the motor to reciprocating motion of the at least one driven shaft; where the head is pivotable in at least two dimensions, relative to the housing; and characterized in that a ratio of a minimum coupling diameter D2 to a maximum handle diameter D6 is about 0.50 or less; or from about 1:2 to about 1:3. In certain embodiments, a ratio of the minimum coupling diameter D2 to a maximum head diameter D1 can be about 0.40 or less. In such embodiments, the head can include a contour-following element, where the contour-following element can include the skin-engaging portion and can be pivotable in three dimensions, relative to the housing.

In order to allow for a more ergonomic shaving and/or handle-holding experience, the handle can further include a power switch on a front side of the handle and a finger rest on a rear side of the handle, where at least a portion of the maximum handle diameter D6 can extend through at least a portion of the finger rest. For example, such a configuration can allow for a two-fingered grip of the handle.

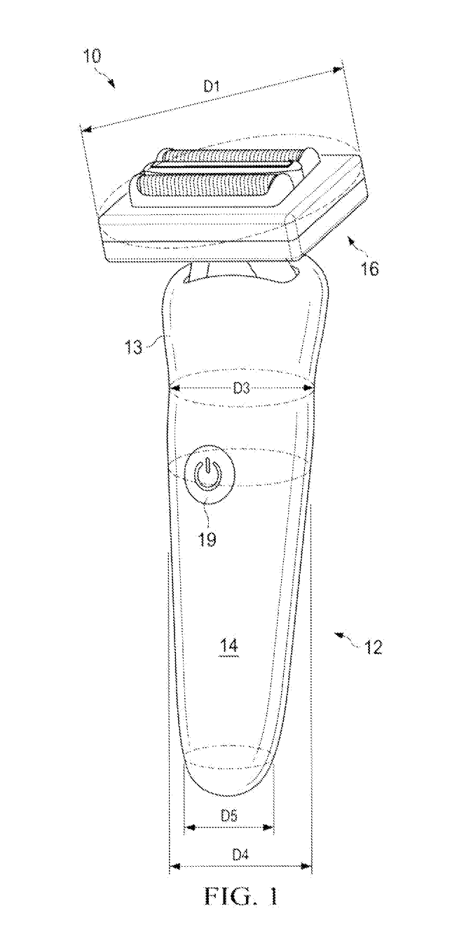

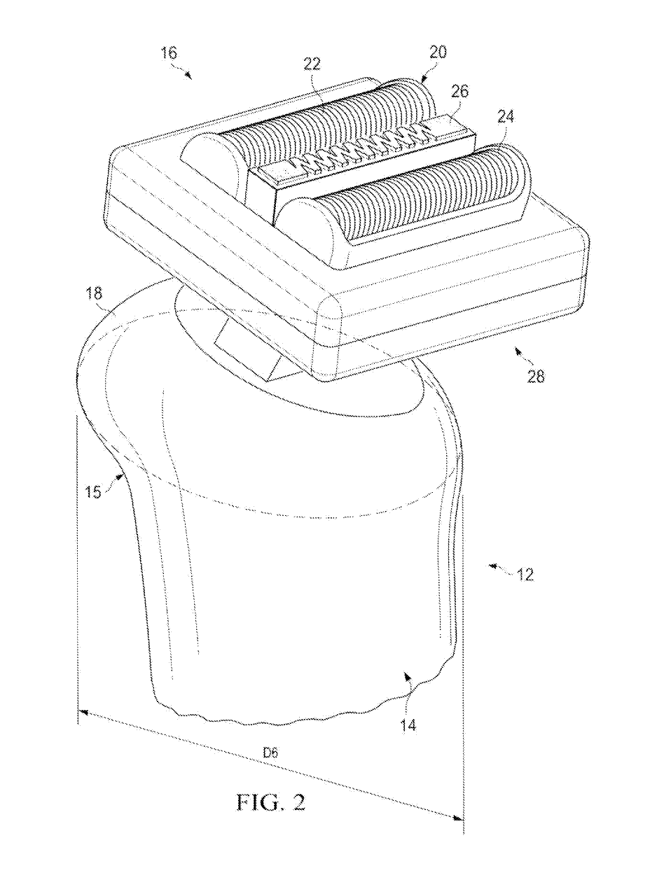

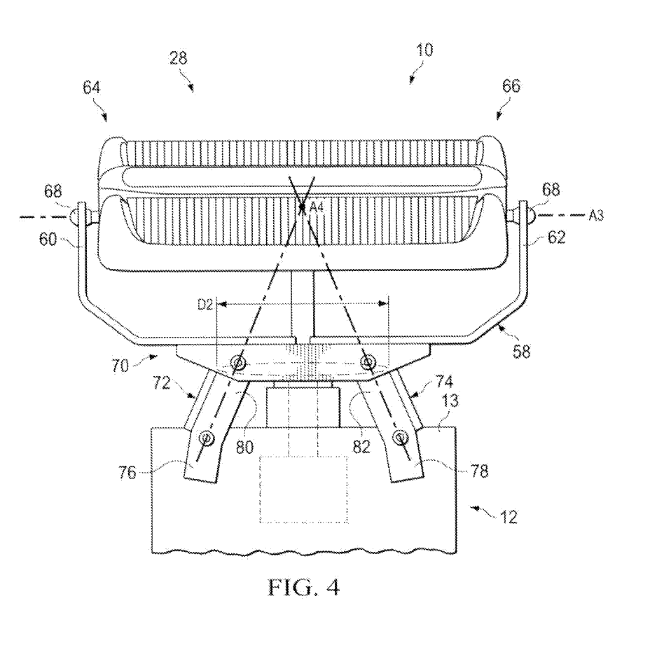

Referring to FIG. 1, an electrically-driven razor 10 is shown. As shown in FIG. 1, the electrically-driven razor 10 can include a handle 12 and a head 16. The handle 12 can include a housing 13, as shown in FIG. 1, and referring to FIGS. 1 and 2, the handle 12 can include a front side 14 and a rear side 15. The handle 12 can further include a coupling (e.g., 70 of FIG. 4), which can link the head 16 to the housing 13. In certain embodiments, the head 16 can be pivotable in at least two dimensions, relative to the housing 13. In certain embodiments, for example, the head 16 can be pivotable in two dimensions, relative to the housing 13, such that the head 16 can be capable of swiveling, relative to the housing 13. In other embodiments, the head 16 can be pivotable in three dimensions, relative to the housing 13, such that the head 16 can be capable of swiveling and tilting, relative to the housing 13. In one embodiment, a user can grip the handle 12 and direct the head 16 to engage skin or hair of the user's face, neck, or other areas of the user's body in order to shave or trim hair therefrom.

To enhance various aspects of a grooming experience, in certain embodiments, the head 16 can be a relatively lightweight head. In such embodiments, and as shown below in Table 1, the head 16 can be lightweight relative to the handle 12, such that a ratio of a weight of the head 16 to a weight of the handle 12 can be less than about 0.21; in other embodiments, less than about 0.20; in other embodiments, less than about 0.19; in other embodiments, less than about 0.18; or in other embodiments, less than about 0.175. In certain embodiments, the ratio of the weight of the head 16 to the weight of the handle 12 is from about 1:5 to about 1:8; or more preferably, from about 1:5 to about 1:7. For purposes of providing the respective weight of the head 16 and weight of the handle 12, in embodiments where the head 16 can be pivotable in two dimensions (i.e., capable of swiveling movement), the head 16 can include those parts that are independently pivotable in two dimensions relative to the housing 13, and the handle 12 can include all other parts. And in embodiments where the head 16 can be pivotable in three dimensions (i.e., capable of swiveling and tilting movement), the head 16 can include those parts that are independently pivotable in three dimensions relative to the housing 13, and the handle 12 can include all other parts.

The coupling (e.g., 70) can be narrow, relative to the handle 12 and the head 16, and can serve to emphasize the separation of the head 16 and the handle 12 and/or facilitate macro-movement of the head 16, relative to the housing 13. In such embodiments, the coupling (e.g., 70) can be narrow relative to the housing 13, such that a ratio of a minimum coupling diameter D2 to a maximum handle diameter D6, which is depicted in FIG. 2, can be about 0.50 or less; in other embodiments, about 0.49 or less; in other embodiments, about 0.48 or less; or in other embodiments, about 0.45 or less. In certain embodiments, the ratio of the minimum coupling diameter D2 to the maximum handle diameter D6 can be from about 1:2 to about 1:3.

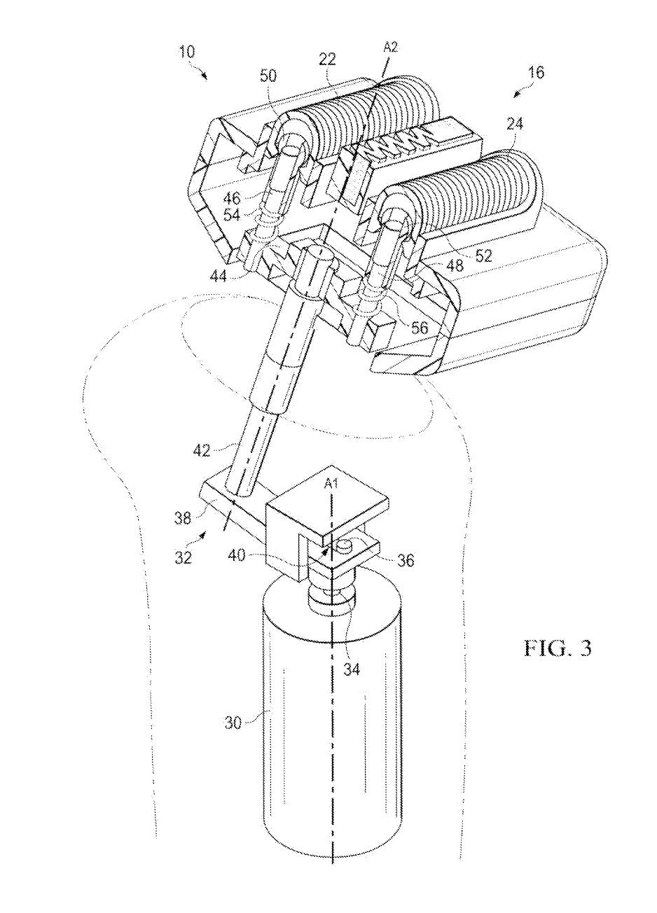

Diameter measurements in this application can refer to diameters of virtual circles that relate to cross-sectional planes of the electrically-driven razor 10. Each virtual circle circumscribes a perimeter of the electrically-driven razor 10 at the particular cross-sectional plane, capturing outermost points of the electrically-driven razor 10 at the particular cross-sectional plane. Such virtual circles can be perpendicularly aligned with respect to a longitudinal axis (e.g., A1 or A2 of FIG. 3) of the electrically-driven razor 10. Thus, in certain embodiments, the minimum coupling diameter D2, as best shown in FIG. 4, can refer to a diameter of a virtual circle at a narrowest portion of the coupling (e.g., 70) with respect to a longitudinal axis (e.g., A2). In certain embodiments, the minimum coupling diameter D2 can be from about 18 mm to about 30 mm; or more preferably, from about 20 mm to about 28 mm. While provision of a virtual circle at a particular cross-sectional plane does not indicate that a corresponding portion of the electrically-driven razor 10 has a circular cross-section, it will be understood that in certain embodiments, one or more portions of an electrically-driven razor can have a circular cross-section, such that a virtual circle and a cross-sectional perimeter of a corresponding portion of the electrically-driven razor at a particular cross-sectional plane are identical.

Referring to FIG. 2, the handle 12 can include a finger rest 18. In certain embodiments, the finger rest 18 can be a projection from the rear side 15 of the handle 12, preferably at or near a top of the rear side 15. In certain embodiments, and as shown in FIG. 2, at least a portion of the maximum handle diameter D6 can extend through at least a portion of the finger rest 18. The maximum handle diameter D6 can be from about 40 mm to about 60 mm; or more preferably, from about 45 mm to about 55 mm. It will be appreciated that, in other embodiments, an electrically-driven razor can include a finger rest of any of a variety of suitable sizes and shapes or the electrically-driven razor can be provided without a finger rest.

In certain embodiments, the handle 12 can include a power switch (e.g., 19) on the front side 14 of the handle 12. As shown in FIG. 1, the power switch can be a button 19, where the electrically-driven razor 10 can be configured to be actuated upon depressing the button 19. However, it will be appreciated that, in other embodiments, an electrically-driven razor can include a power switch of any of a variety of suitable types and configurations. In such configurations where the electrically-driven razor 10 includes both a finger rest 18 and a power switch 19, the electrically-driven razor 10 can allow for a two-fingered grip of the handle 12. That is, in such embodiments, the finger rest 18 can be configured to engage, for example, the user's index finger, while the power switch (e.g., 19), on a front side 14 of the handle 12, can be configured to be accessible to, for example, the user's thumb. Such a grip can enhance the user's shaving and/or handle-holding experience.

Additionally, the coupling (e.g., 70) can be narrow relative to the head 16, such that a ratio of the minimum coupling diameter D2 to a maximum head diameter D1 can be about 0.40 or less; in other embodiments, about 0.39 or less; or in other embodiments, about 0.35 or less. In one embodiment, the maximum head diameter D1 can be about 63 mm. In certain embodiments, the maximum head diameter D1 can be from about 53 mm to about 73 mm; or more preferably, from about 58 mm to about 68 mm.

The housing 13 of the handle 12 can be shaped to provide a user with an ergonomic gripping surface, as shown in FIG. 1. In one such embodiment, a handle diameter D3 can be about 39 mm while a lower, adjacent handle diameter D4 can be about 41 mm, slightly wider than the handle diameter D3. Furthermore, the housing 13 can be substantially cone-shaped. As best shown in FIG. 1, a diameter of the housing 13 generally decreases from a top of the housing 13 down to a handle diameter D5, which is shown to be near a bottom of the housing 13. As described above, in certain embodiments, each of diameters D3, D4, D5, and D6 can have a circular cross-section, such that the respective, corresponding virtual circles and actual cross-sectional perimeters at the particular cross-sectional plane are identical. In certain embodiments, each of diameters D3, D4, D5, and D6 can have a substantially circular cross-section, such that the respective radii of the virtual circle and the actual cross-sectional perimeter of a corresponding portion of the electrically-driven razor at the particular cross-sectional plane for each of D3, D4, D5, and D6 can deviate from each other by 10% or less at any given angular position. It will be appreciated, however, that a housing and/or handle can have a cylindrical shape or any other suitable shape or configuration. Similarly, it will be appreciated that while the head 16 in FIGS. 1-4 is shown to have a substantially cuboid shape, a head may have any of a variety of other suitable shapes and configurations.

The head 16 can further include a skin-engaging portion 20, where the skin-engaging portion 20 can be constructed to contact skin or hair of the user's face, neck, or other areas of the body at which the user may wish to shave or trim hair. The skin-engaging portion 20 can include one or more hair cutting units (e.g., 22, 24, and 26). In certain embodiments, the one or more hair cutting units can include a first foil-type cutting unit and a second foil-type cutting unit, both constructed to cut short hairs. Generally, each of the foil-type cutting units can include a blade-type under cutter 22 and 24, respectively, and a foil-type upper cutter disposed over each respective blade-type under cutter 22 and 24. As shown in FIGS. 1-4, and for illustration purposes only, the foil-type upper cutters have been removed in order to show the blade-type under cutters 22 and 24. A center cutting unit 26, shown in FIG. 2 to be between the blade-type under cutters 22 and 24, can be a non-foil-type cutting unit, which can be constructed to cut long hairs. However, it will be appreciated that a skin-engaging portion can include other suitable cutting units in any of a variety of suitable configurations.

In certain embodiments, the head 16 can further include a contour-following element 28. The contour-following element 28 can be pivotable relative to the housing 13. In some embodiments, the contour-following element 28 can be pivotable in three dimensions relative to the housing 13. In certain embodiments, the head 16, in its entirety, can comprise the contour-following element 28, such that the entire head 16 can be pivotable relative to the housing 13. As such, in certain embodiments, the contour-following element 28 can include the skin-engaging portion 20. In other embodiments, however, only a portion of the head 16 can be designated as the contour-following element 28, such that the contour-following element 28 can be pivotable relative to the housing 13, and possibly, other portions of the head 16. In certain embodiments, the contour-following element 28 can be pivotable in two dimensions relative to the housing 13.

The electrically-driven razor 10 can further include a motor 30, as depicted in FIG. 3. The motor 30 can be contained substantially within the housing 13. Without wishing to be bound by theory, it is believed that by substantially containing the motor 30 within the housing 13, as opposed to, for example, the head 16, the handle 12 can bear a greater proportion of a weight of the electrically-driven razor 10. In certain embodiments, the motor 30 can be a DC motor; and in other embodiments, the motor 30 can be a linear drive motor. It will be appreciated, however, that any of a variety of suitable motors may be used in an electrically-driven razor.

The electrically-driven razor 10 can further include a transmission 32. The transmission 32 can be constructed to translate rotary motion of the motor 30 to reciprocating motion of at least one driven shaft. As shown in FIG. 3, the motor 30 can include a drive shaft 34. The drive shaft can define a first longitudinal axis A1, as shown in FIG. 3. The drive shaft 34 can be coupled to a drive pin 36, which can be arranged eccentrically with respect to the drive shaft 34. In certain embodiments, the drive shaft 34 can be directly coupled to the drive pin 36; and in other embodiments, a gearing can be positioned there between. The transmission 32 can further include one or more crank arms. As depicted in FIG. 3, a crank arm 38 can include at one end a slotted hole 40, which can be configured to receive the drive pin 36, and at another end, the crank arm 38 can be coupled to an intermediate shaft 42, which, in certain embodiments, can be rotationally constrained with respect to the crank arm 38. The intermediate shaft 42 can define a second longitudinal axis A2, which can be inclined with respect to the first longitudinal axis A1, as shown in FIG. 3. In such embodiments, the motor 30 can be activated to cause rotation of the drive shaft 34 about the first longitudinal axis A1. The rotation of the drive shaft 34 can cause the drive pin 36 to rotate eccentrically with respect to the drive shaft 34. The eccentric rotation of the drive pin 36 within the slotted hole 40 can cause the drive pin 36 to engage the crank arm 38, thereby resulting in reciprocating pivoting movement of the crank arm 38, which can rotate the intermediate shaft 42 about the second longitudinal axis A2.

The intermediate shaft 42 can be coupled to a bridge 44. In certain embodiments, the bridge 44 can be rotationally constrained with respect to the intermediate shaft 42. Thus, in such embodiments, the reciprocating pivoting movement of the crank arm 38 can be transmitted through the rotation of the intermediate shaft 42 to reciprocating pivoting movement of the bridge 44. The electrically-driven razor 10 can further include at least one driven shaft, and as depicted in FIG. 3, the at least one driven shaft can be a first driven shaft 46 and a second driven shaft 48, both of which can be coupled to the bridge 44. In such embodiments, the first driven shaft 46 and the second driven shaft 48 can be rotationally and axially constrained to the bridge 44, such that the first driven shaft 46 and the second driven shaft 48 can experience reciprocating motion. In certain embodiments, each of the first driven shaft 46 and the second driven shaft 48 can be offset with respect to the second longitudinal axis A2, as defined by the intermediate shaft 42, but substantially parallel thereto.

In certain embodiments, each of the first driven shaft 46 and the second driven shaft 48 can extend into the head 16, and in certain embodiments, each of the first driven shaft 46 and the second driven shaft 48 can be coupled to one of the one or more hair cutting units. As depicted, for example, in FIG. 3, the first driven shaft 46 and the second driven shaft 48 can be coupled to the first blade-type under cutter 22 and the second blade-type under cutter 24, respectively. In certain embodiments, the first driven shaft 46 can be coupled to the first blade-type under cutter 22 with a first bearing sleeve 50, and the second driven shaft 48 can be coupled to the second blade-type under cutter 24 with a second bearing sleeve 52. In such embodiments, the first bearing sleeve 50 and the second bearing sleeve 52 can be rotatable and axially displaceable with respect to the first driven shaft 46 and the second driven shaft 48, respectively. As shown in FIG. 3, the first bearing sleeve 50 and the second bearing sleeve 52 can be biased by a first spring 54 and a second spring 56, respectively. Such an arrangement can allow the reciprocating motion of the first driven shaft 46 and the second driven shaft 48 to be transferred to the first blade-type under cutter 22 and the second blade-type under cutter 24, respectively.

In certain embodiments, the transmission 32 can be substantially, or at least partially, contained within the housing 13. And in some embodiments, the transmission 32 can allow for a relatively reduced number of parts compared to other, conventional razors, thereby requiring fewer parts to be positioned, for example, within the head 16. As such, to maintain a lightweight head, in certain embodiments, the electrically-driven razor 10 can include a head 16 where neither the motor 30 nor the transmission 32 are contained therein. Such a beneficial configuration of the transmission 32 can further serve to emphasize the separation of the head 16 and the handle 12 and/or facilitation of macro-movement of the head 16, relative to the handle 12, as previously described herein with respect to a relatively narrow coupling. Without wishing to be bound by theory, it is believed that by providing a lightweight head and a relatively narrow coupling, the contour-following element 28 of the head 16 can exhibit a lower inertia, more easily adapt to skin contour, and experience improved flexing at various neck and facial positions.

As described herein, in certain embodiments, the contour-following element 28 can be pivotable relative to the housing 13. In certain embodiments, the contour-following element 28 can be pivotable with respect to the first driven shaft 46 and the second driven shaft 48. FIG. 4 illustrates mechanisms by which such movement can be realized. As shown in FIG. 4, the handle 12 can further include a first support member 58, which can include a first tab 60 and a second tab 62. In certain embodiments, the first support member 58 can extend along substantially a length of the head 16, where the first tab 60 can be rotatably coupled to a first end 64 of the contour-following element 28 and the second tab 62 can be rotatably coupled to a second end 66 of the contour-following element 28, only a portion of which is shown in FIG. 4 in order to best view the first support member 58. In such embodiments, respective connection points 68 between the first tab 60 and the first end 64 of the contour-following element 28 and the second tab 62 and the second end 66 of the contour-following element 28 can define a swivel axis A3 about which the contour-following element 28 is capable of swiveling.

The coupling can include a four-link support mechanism 70. As depicted in FIG. 4, the four-link support mechanism 70 can include a first arm 72 and a second arm 74. In certain embodiments, each of the first arm 72 and the second arm 74 can include a lower portion 76, 78 and an upper portion 80, 82. The lower portion 76, 78 of each of the first arm 72 and the second arm 74 can be rotatably coupled to the housing 13, a portion of which is depicted in the schematic diagram of FIG. 4. The upper portion 80, 82 of each of the first arm 72 and the second arm 74 can be rotatably coupled to the first support member 58. In certain embodiments, the four-link support mechanism 70 can allow for tilting movement of the contour-following element 28, relative to the housing 13. In certain embodiments, the contour-following element 28 can tilt about a virtual tilt axis A4, as shown in FIG. 4. The virtual tilt axis A4 can be defined a line that is perpendicular with respect to the swivel axis A3 and that passes through a point of intersection between lines extrapolating from links on the first arm 72 and the second arm 74, respectively, as shown in FIG. 4. In a neutral position, as shown in FIG. 4, the virtual tilt axis A4 can also be perpendicular with respect to the second longitudinal axis A2. While the embodiment in FIG. 4 is shown to be capable of both swiveling and tilting movement, it will be appreciated that in other embodiments, a head of an electrically-driven razor can be fixed with respect to a handle.

The devices of Inventive Example 1 and the listed Comparative Examples were disassembled to the extent necessary in order for the head and handle/body of each device to be weighed. Results for the measurements are shown in Table 1 below.

TABLE 1
Comparison of Devices Based on Ratio of
Weight of Head to Weight of Handle/Body

| | w_{b}, Weight | wₕ, Weight | |
|---|---|---|---|
| | of Handle/Body | of Head | Ratio |
| Device Name | (g) | (g) | (wₕ/w_{b}) |
| Comparative Example 1 | 173.15 | 41.75 | 0.2411 |
| Comparative Example 2 | 136.07 | 35.94 | 0.2641 |
| Comparative Example 3 | 130.85 | 33.02 | 0.2524 |
| Comparative Example 4 | 139.55 | 36.98 | 0.2650 |
| Comparative Example 5 | 127.55 | 74.62 | 0.5850 |
| Comparative Example 6 | 143.64 | 56.27 | 0.3917 |
| Comparative Example 7 | 113.62 | 68.85 | 0.6060 |
| Comparative Example 8 | 102.5 | 61.4 | 0.5990 |
| Comparative Example 9 | 114.1 | 81.25 | 0.7121 |
| Comparative Example 10 | 99.86 | 90.04 | 0.9017 |
| Inventive Example 1 | 157 | 27 | 0.1720 |

Referring to the results in Table 1, Inventive Examples 1 exhibits the lowest ratio of all the measured devices. As such Inventive Example 1 possesses a ratio of the weight of the head to the weight of the handle (and/or body) lower than that of any of the devices of the Comparative Examples.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

What is claimed:

1. An electrically-driven razor, comprising:
a handle, the handle comprising:
a housing;
a motor being contained substantially within the housing;
a transmission;
at least one driven shaft; and
a coupling; and
a head, the head comprising a skin-engaging portion; wherein
the coupling links the head to the housing,
the at least one driven shaft extends into the head, and
the head is pivotable in at least two dimensions, relative to the housing;
wherein
the transmission is constructed to translate rotary motion of the motor to reciprocating motion of the at least one driven shaft thereby reaching a ratio of a weight of the head to a weight of the handle being less than about 0.21.

2. The electrically-driven razor according to claim 1, wherein the ratio of the weight of the head to the weight to the handle is from about 1:5 to about 1:8.

3. The electrically-driven razor according to claim 2, wherein the head comprises a contour-following element, the contour-following element comprising the skin-engaging portion and being pivotable in three dimensions, relative to the housing.

4. The electrically-driven razor according to claim 3, wherein the handle further comprises a first support member having a first tab and second tab, the first support member extending along substantially a length of the head, wherein the first tab is rotatably coupled to a first end of the contour-following element and the second tab is rotatably coupled to a second end of the contour-following element.

5. The electrically-driven razor according to claim 4, wherein respective connection points between the first tab and the first end of the contour-following element and the second tab and the second end of the contour-following element define a swivel axis about which the contour-following element is capable of swiveling.

6. The electrically-driven razor according to claim 5, wherein the coupling comprises a four-link support mechanism having a first arm and a second arm, each of the first arm and the second arm having a lower portion and an upper portion, wherein the lower portion of each of the first arm and the second arm is rotatably coupled to the housing, and wherein the upper portion of each of the first arm and the second arm is rotatably coupled to the first support member.

7. The electrically-driven razor according to claim 6, wherein the four-link support mechanism allows for tilting movement of the contour-following element, relative to the housing.

8. The electrically-driven razor according to any of claim 7, wherein the skin-engaging portion includes one or more hair cutting units.

9. The electrically-driven razor according to claim 8, wherein the at least one driven shaft comprises a first driven shaft and a second driven shaft, and wherein each of the first driven shaft and the second driven shaft is coupled to one of the one or more hair cutting units.

10. The electrically-driven razor according to claim 9, wherein the first driven shaft and the second driven shaft are coupled by a bridge.

11. The electrically-driven razor according to claim 10, wherein the bridge is coupled to an intermediate shaft, such that the bridge is rotationally constrained relative to the intermediate shaft.

12. The electrically-driven razor according to claim 11, wherein the one or more hair cutting units comprises a first foil-type cutting unit and a second foil-type cutting unit, wherein the first driven shaft is coupled to the first foil-type cutting unit with a first bearing sleeve, wherein the second driven shaft is coupled to the second foil-type cutting unit with a second bearing sleeve, and wherein the first bearing sleeve and the second bearing sleeve are rotatable and axially displaceable with respect to the first driven shaft and the second driven shaft, respectively.

13. The electrically-driven razor according to claim 1, wherein the ratio of the weight of the head to the weight of the handle is less than about 0.20.

14. An electrically-driven razor, comprising:
a handle, the handle comprising:
a housing;
a motor, the motor being contained substantially within the housing;
a transmission;
at least one driven shaft; and
a coupling; and
a head, the head comprising a skin-engaging portion; wherein
the coupling links the head to the housing,
the at least one driven shaft extends into the head,
the head is pivotable in at least two dimensions, relative to the housing;
wherein
the transmission is constructed to translate rotary motion of the motor to reciprocating motion of the at least one driven shaft thereby reaching a ratio of a minimum coupling diameter to a maximum handle diameter being about 0.50 or less.

15. The electrically-driven razor according to claim 14, wherein a ratio of a minimum coupling diameter to a maximum handle diameter is from about 1:2 to about 1:3.

16. The electrically-driven razor according to claim 14, wherein the handle further comprises a power switch on a front side of the handle and a finger rest on a rear side of the handle, and wherein at least a portion of the maximum handle diameter extends through at least a portion of the finger rest; and/or wherein a ratio of the minimum coupling diameter to a maximum head diameter is about 0.40 or less.

17. The electrically-driven razor according to any of claim 15, wherein the head comprises a contour-following element, the contour-following element comprising the skin-engaging portion and being pivotable in three dimensions, relative to the housing.
